(19) United States
(12) Patent Application Publication
(10) Pub. No.: US 2020/0387053 A1
(43) Pub. Date: Dec. 10, 2020

(54) FOLDABLE CAMERA STAND

(71) Applicant: Ipevo, Inc., Sunnyvale, CA (US)

(72) Inventor: ROYCE YU-CHUN HONG, Taipei (TW)

(21) Appl. No.: 16/436,243

(22) Filed: Jun. 10, 2019

(51) Int. Cl. G03B 17/56; F16M 11/08; F16M 11/38

(52) U.S. Cl. CPC G03B 17/561; F16M 2200/068; F16M 11/38; F16M 11/08

(57) ABSTRACT

A foldable camera stand is disclosed which includes an elongated container having a removable lid, a camera connected on a first end of the removable lid, a mounting fixture pivotally connected to a second end of the lid, the mounting fixture having a protruding member, an arm having a first end pivotally connected to the container and a second end pivotally connected to the protruding member, wherein when the removable lid covers the container, the camera and the arm are kept inside the container, and when the removable lid is lifted to an elevated position, the arm alone holds the removable lid in the elevated position without drifting.

### FIELD

The present disclosure relates generally to equipment assisting image taking, and, more particularly, to a foldable camera stand.

### BACKGROUND

In many occasions when taking images of a document or an object on a platform, a stand is needed for mounting a camera for stability and repeatability, etc. The camera can take either still pictures or videos, and then feed the image data to a computer or a large display or both. Such a system can be used in a classroom or a conference in place of an overhead projector.

A conventional camera stand includes a base serving as the platform, a vertical rail rigidly mounted on the base, and a horizontal arm slidably attached to the vertical rail for holding a camera above the platform. The horizontal arm may swing around and slide up and down the vertical rail catering to different imaging needs. A problem with the conventional camera stand is that it is generally bulky and not easy to travel with.

As such, it is desirable to provide a camera stand that is both compact and versatile.

### SUMMARY

It is an object of the present invention to provide a foldable camera stand for easy transportation yet versatile and easy to operate.

Disclosed and claimed herein is a foldable camera stand which includes an elongated container having a removable lid, a camera connected on a first end of the removable lid, a mounting fixture pivotally connected to a second end of the lid, the mounting fixture having a protruding member, an arm having a first end pivotally connected to the container and a second end pivotally connected to the protruding member, wherein when the removable lid covers the container, the camera and the arm are kept inside the container, and when the removable lid is lifted to an elevated position, the arm alone holds the removable lid in the elevated position without drifting.

Other aspects, features, and techniques will be apparent to one skilled in the relevant art in view of the following detailed description of the embodiments.

### BRIEF DESCRIPTION OF THE DRAWINGS

The drawings accompanying and forming part of this specification are included to depict certain aspects of the present disclosure. A clearer conception of the present disclosure, and of the components and operation of systems provided with the present disclosure, will become more readily apparent by referring to the exemplary, and therefore non-limiting, embodiments illustrated in the drawings, wherein like reference numbers (if they occur in more than one view) designate the same elements. The present disclosure may be better understood by reference to one or more of these drawings in combination with the description presented herein. It should be noted that the features illustrated in the drawings are not necessarily drawn to scale.

FIG. 1 is a perspective view of a foldable camera stand folded into an elongated box according to an embodiment of the present disclosure.

FIG. 2 is a side view of the foldable camera stand shown in FIG. 1 being extended.

FIG. 3 is a perspective view of the extended foldable camera stand shown in FIG. 2.

FIG. 4 is another perspective view of the extended foldable camera stand shown in FIG. 2.

FIG. 5 is yet another perspective view of the extended foldable camera stand shown in FIG. 2.

FIG. 6 is a perspective view of the foldable camera stand of the present disclosure in use.

FIG. 7 is a perspective view of an extended foldable camera stand according to an embodiment of the present disclosure.

### DESCRIPTION

One aspect of the disclosure relates to a foldable camera stand. Embodiments of the present disclosure will be described hereinafter with reference to the attached drawings.

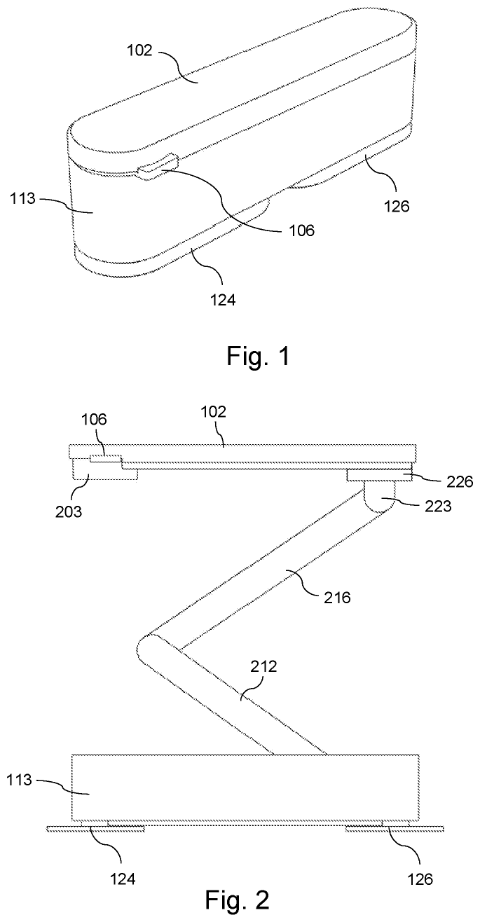

FIG. 1 is a perspective view of a foldable camera stand folded into an elongated box according to an embodiment of the present disclosure. The elongated box includes a removable lid 102 on top of a container 113. There are two feet 124 and 126 at the bottom of the container 113. A handle 106 protruding from below the lid 102 is attached to a camera unit (not shown in FIG. 1) for rotating thereof. As shown in FIG. 1, the foldable camera stand is both compact and self-contained for easy transportation.

FIG. 2 is a side view of the foldable camera stand shown in FIG. 1 being extended. As shown in FIG. 2, the lid 102 is raised to an elevated position by a pair of pivotally connected arms 212 and 216. A lower end of the arm 212 is pivotally connected to the container 113, while an upper end of the arm 212 is pivotally connected to a lower end of the arm 216. An upper end of the arm 216 is pivotally connected to a protruding member 223 of a mounting fixture 226, which in turn is pivotally connected to an end of the lid 102. A camera 203 is pivotally connected to the other end of the lid 102. The handle 106 is to facilitate the rotation of the camera 203 around an axis perpendicular to a plane of the lid 102.

The joints (not shown) in the aforementioned pivotal connections can maintain the foldable camera stand in a set position without drifting when there is no external force applied thereto. However, a user can easily force the lid 102 in up and down, swivel and tilt motions. In embodiments, these joints employ a friction control mechanism which includes screws for adjusting friction, to maintain the arms' set positions. In other embodiments, the set positions are maintained by spring forces or a combination of both frictions and spring forces. For aesthetic reasons, the joint's structural elements are enclosed in, for instance, the arms 212 and 216, and not visible to the outside world. In addition, the arms 221 and 216 can be hollow with electrical wires running through the hollow spaces in the arms 221 and 216 and the protruding member 223 between the lid 102 and the container 113.

Referring again to FIG. 2, when aligned with the container 113, the lid 102 can be pushed down toward the container 113 with the arms 212 and 216 folded and retrieved into the container 113 with the lid 102 on top as shown in FIG. 1. In embodiments, the lid 102 may be secured to the container 113 by a strap (not shown) or a combination of pins and hooks (not shown) for easy transportation.

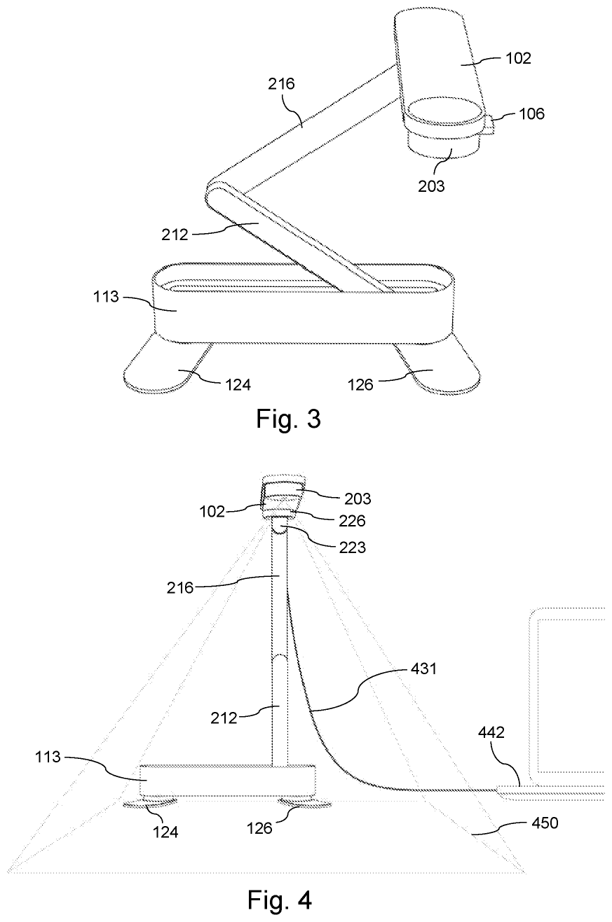

FIG. 3 is a perspective view of the extended foldable camera stand shown in FIG. 2. As shown in FIG. 3, the feet 124 and 126 are pivotally attached to the bottom of the container 113, and each can swivel 360 degrees around a vertical axis (not shown). When the feet 124 and 126 swivel to positions in alignment with the container 113 as shown in FIG. 1, the foldable camera stand takes up less space for easy transportation. When the feet 124 and 126 swivel to positions approximately perpendicular to the container 113 as shown in FIG. 3, the foldable camera stand is more stable to accommodate an out-reaching camera 203.

As shown in FIG. 3, the lid 102 swivels 90 degrees around a vertical axis (not shown) to a position perpendicular to the container 113, so that the camera 203 can have the farthest reach away from the container 113. In this case, the feet 124 and 126 swivels to approximately the same direction as the lid 102 to prevent the foldable camera stand to fall over under the weight of the camera 203. In embodiments, the joint (not shown) between the mounting fixture 226 and the lid 102 shown in FIG. 2 allows the lid 102 to swivel 360 degrees relative to the mounting fixtures 226. However, marks or clicking sounds may be presented at some right angles such as 90 degrees and 180 degrees, etc.

FIG. 4 is another perspective view of the extended foldable camera stand shown in FIG. 2. As shown in FIG. 4, the foldable camera stand is raised to its full height by aligning the arms 212 and 216 in a vertical line. A rectangular line 450 marks a field of viewing by the camera 203. In embodiments, the rectangular line 450 has an aspect ratio of 16:9. The handle 106 shown in FIG. 1 is for rotating the camera around a vertical axis, so than the rectangular line 450 may have a 9:16 aspect ratio when the camera 203 is rotated 90 degrees.

As shown in FIG. 4, an exemplary universal serial bus (USB) cable 431 connects the camera 203 to a computer 442, so that images taken by the camera 203 can be immediately transmitted to the computer 442 which in turn may be connected to a display system such as a projector (not shown). The computer 442 may also function as a controller to control the operations of the camera 203, such as shuttle speed, aperture, focus and mode switching between photo and video. Alternately, the camera 203 may have a radio frequency, such as Bluetooth or Wi-Fi, connection. In such case, a user may run a software application on a smartphone to control the operations of the camera 203.

Although the camera 203 is depicted as a permanent camera mounted on the lid 102, in other embodiments, the lid 102 may simply provide a mounting screw for mounting a regular camera, or a clamp or a magnet to attach a smartphone which has a built-in camera.

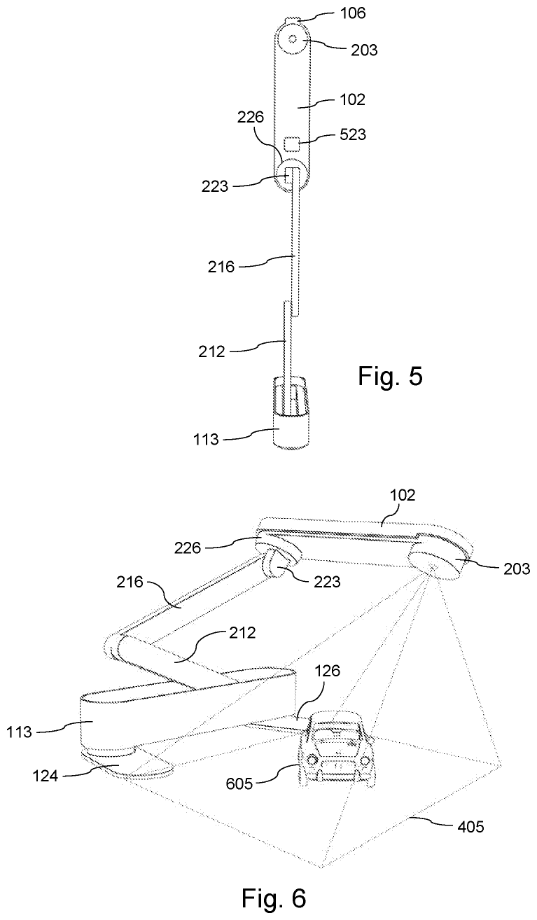

FIG. 5 is yet another perspective view of the extended foldable camera stand shown in FIG. 2. As shown in FIG. 5, the lid 102 swivels 90 degrees to a vertical plane made possible by the joint between the protruding member 223 and the upper end of the arm 216. In this case, the camera 203 becomes front facing. In embodiments, the joint between the protruding member 223 and the arm 216 allows the lid 102 to have approximately 180 degree of freedom between the position where the camera 203 is front facing shown in FIG. 5 and a position where the camera 203 is rear facing (not shown).

FIG. 5 also reveals a lighting module 523 embedded in the lid 102 for illuminating the platform area when there is not enough ambient light or special effects are desired.

FIG. 6 is a perspective view of a foldable camera stand of the present disclosure in use. In this case, a model car 605 is placed on the platform within the viewing field 405 of the camera. The lid 102 align with the camera 203 are tilted at an angle so that the camera 203 can take a perspective view picture of the model car 605. As shown in FIG. 6, the tilting of the lid 102 can be facilitated by the pivotal joint (not shown) between the protruding member 223 and the upper end of the arm 216. In embodiments, the lid 102 is provided at least 180 degrees of freedom of tilting around an axis perpendicular to an elongated direction of the arm 216. On the other hand, the pivotal joint (not shown) between the lower end of the arm 216 and the upper end of the arm 212 can also affect the tilting of the lid 102 as the angle between the arm 216 and the container 113 changes as the arm 216 swivels around the pivotal joint. However, the swivel of the arm 216 changes the height of the lid 102 as well.

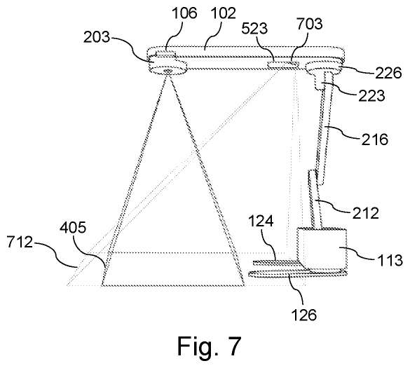

FIG. 7 is a perspective view of an extended foldable camera stand according to an embodiment of the present disclosure that shows a light source 703 placed in a concave space of the lighting module 523. The light source 703 shines light in a field 712 overlaying the viewing field 405 of the camera 203. In embodiments, the light source 703 are light emitting diodes (LEDs) that are exemplarily powered by batteries (not shown) stored in the lid 102.

Even though the foldable camera stand shown in FIGS. 2-7 employs two pivotally linked arms 212 and 216 for lifting the lid 203 and thus the camera 203, in another embodiment, a single arm (not shown) may be used instead. A lower end of the single arm is pivotally mounted to the container 113, and an upper end of the single arm is pivotally connected to the protruding member 223. The single arm can also be folded into the container 113 when the lid 102 is pressed down to cover the container 113.

While this disclosure has been particularly shown and described with references to exemplary embodiments thereof, it shall be understood by those skilled in the art that various changes in form and details may be made therein without departing from the spirit of the claimed embodiments.

What is claimed is:

1. A camera stand comprising:
an elongated container having a removable lid;
a camera connected on a first end of the removable lid;
a mounting fixture pivotally connected to a second end of the lid opposite to the first end, the mounting fixture having a protruding member;
an arm having a first end pivotally connected to the container and a second end pivotally connected to the protruding member,
wherein when the removable lid covers the container, the camera and the arm are kept inside the container, and when the removable lid is lifted to an elevated position, the arm alone holds the removable lid in the elevated position without drifting.

2. The camera stand of claim 1, wherein the camera is pivotally connected to the removable lid.

3. The camera stand of claim 1, wherein the camera can be removed from the removable lid.

4. The camera stand of claim 1, wherein the pivotal connection between the mounting fixture and the removable lid includes a joint with a friction control mechanism to prevent drifting.

5. The camera stand of claim 1, wherein the pivotal connection either between the arm and the container or between the arm and the protruding member includes a joint with a friction control mechanism to prevent drifting.

6. The camera stand of claim 1, wherein the arm is made of a rigid material.

7. The camera stand of claim 1, wherein the arm is hollow and conceals electrical wires.

8. The camera stand of claim 1, wherein the arm has two sections pivotally connected by a joint having a friction control mechanism to prevent drifting.

9. The camera stand of claim 1 further comprising a handle protruding from the camera to facilitate a rotation thereof

10. The camera stand of claim 1 further comprising a foot pivotally mounted to a bottom of the container.

11. The camera stand of claim 1 further comprising a terminal for connecting to a signal carrier between the camera and an external device.

12. The camera stand of claim 11, wherein the signal carrier is selected from the group consisting of a serial bus cable, a Bluetooth connection and a Wi-Fi connection.

13. The camera stand of claim 11, wherein the external device is selected from the group consisting of a computer, a projector and a data storage device.

14. The camera stand of claim 1 further comprising a lighting source mounted in a concave space in the removable lid.

15. A camera stand comprising:
an elongated container having a removable lid;
a camera mount connected on a first end of the removable lid;
a mounting fixture pivotally connected to a second end of the lid opposite to the first end, the mounting fixture having a protruding member;
an arm having a first end pivotally connected to the container and a second end pivotally connected to the protruding member,
wherein when the removable lid covers the container, the camera mount and the arm are kept inside the container, and when the removable lid is lifted to an elevated position, the arm alone holds the removable lid in the elevated position without drifting.

16. The camera stand of claim 15, wherein the camera mount is pivotally connected to the removable lid, wherein the pivotal connection having a friction control mechanism to prevent drifting.

17. The camera stand of claim 15, wherein the camera mount includes a member selected from the group consisting of a screw, a clamp and a magnet.

18. The camera stand of claim 15, wherein the pivotal connection either between the arm and the container or between the arm and the protruding member includes a joint with a friction control mechanism to prevent drifting.

19. The camera stand of claim 15, wherein the arm is made of a rigid material.

20. The camera stand of claim 15, wherein the arm is hollow and conceals electrical wires.

21. The camera stand of claim 15, wherein the arm has two sections pivotally connected by a joint having a friction control mechanism to prevent drifting.

22. The camera stand of claim 15 further comprising a foot pivotally mounted to a bottom of the container.
